(19) United States
(12) Patent Application Publication
(10) Pub. No.: US 2009/0277094 A1
(43) Pub. Date: Nov. 12, 2009

(54) Hunting blind with one-way windows

(76) Inventor: Harris R. Ward, Shalimar, FL (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/149,671

(22) Filed: May 6, 2008

(51) Int. Cl. E05D 15/06; A01M 31/00

(52) U.S. Cl. 49/413; 43/1

(57) ABSTRACT

The hunting blind with one-way windows is constructed of four rigid panels to have four walls and a fifth rigid roof panel. Preferably, at least three of the panels are provided with a window frame, the frames having multiple tracks for multiple sliding panes in each frame. The window panes are coated or formed to provide one way vision, i.e., the hunter or photographer in the blind can see out through the panes, but wildlife exterior to the blind cannot see into the blind. When the hunter wishes to make a shot, he/she slides one of the panes open to provide a clear shot to the outside from the blind. The panes may be removed and replaced with inexpensive opaque panels when the blind is unused for some time, thus allowing the one way panes to be stored and protected from damaging sunlight and ultraviolet.

### BACKGROUND OF THE INVENTION

1. Field of the Invention

The present invention relates generally to hunting accessories and paraphernalia, and particularly to a hunting blind with one-way windows for use by hunters, wildlife photographers, etc.

2. Description of the Related Art

Hunting blinds have been used for generations to conceal hunters, wildlife photographers, automated equipment used in wildlife research, etc. The typical hunting blind is economically constructed, to the point that the openings for the hunter or photographer are often closed with native brush, curtains, or other lightweight materials. The problem with such materials is that they allow the wind and/or precipitation to blow into the blind; they do not provide a good seal against the weather. As hunting seasons are typically in the fall when the weather is turning colder, a conventional hunting blind is not a particularly comfortable site at those times.

Some blinds have been constructed in the past with openable or removable solid panels for the hunter or photographer to view the wildlife external to the blind. However, these rigid or solid panels have generally been formed of opaque materials, with removal of at least one of the panels being necessary for the hunter or photographer to have an outside view. Once the panel is removed, the same problem occurs of weather entering the blind.

Thus, a hunting blind with one-way windows solving the aforementioned problems is desired.

### SUMMARY OF THE INVENTION

The hunting blind with one-way windows is constructed of four rigid wall panels and a rigid roof panel. The panels may have a camouflage pattern(s) on their exterior surfaces. At least one wall panel, and preferably three or more of the wall panels, is provided with a window frame therein, with the window frame having multiple tracks to provide for the sliding installation of multiple window panes. Each of the panes is coated or otherwise formed to provide a one way view such that a person within the blind can see out through the pane, but wildlife outside the blind cannot see into the blind. Thus, when all the windows are closed, the interior of the blind is a relatively comfortable place in cooler weather. When the hunter or photographer wishes to make a shot, he or she need only slide one of the panes to the side within its window frame. In some instances, there may be sufficient light transmission to allow a photographer to take photos without opening the window. In any event, the person(s) within the blind remains concealed at all times, until the window is opened immediately before taking the shot.

The various window panes are also removable. When the blind is to be unused for some period of time, but the blind is to remain on site, the hunter or photographer may lift the window panes from their frames and replace them with relatively inexpensive opaque sheet material (e.g., plywood, plasticized fiberboard such as Masonite, etc.). Thus, the exposure of the window panes to sunlight and ultraviolet may be minimized to preserve the panes and their one way coatings when not in use.

These and other features of the present invention will become readily apparent upon further review of the following specification and drawings.

### BRIEF DESCRIPTION OF THE DRAWINGS

FIG. 1 is an environmental, perspective view of a hunting blind with one-way windows according to the present invention.

FIG. 2 is a side elevation view in section through the blind, showing further details thereof.

FIG. 3 is a detailed side elevation view in section through one wall of the blind, showing the removal and insertion of alternative panels in the window openings.

Similar reference characters denote corresponding features consistently throughout the attached drawings.

### DETAILED DESCRIPTION OF THE PREFERRED EMBODIMENTS

The present invention comprises various embodiments of a hunting blind with each of the embodiments including a series of one-way windows, i.e., window panes coated or otherwise formed to transmit light from the exterior of the blind to its interior, but blocking light transmission from the interior outward through the panes to the exterior of the blind. Thus, a hunter, photographer, etc. within the blind can see game or wildlife within the field of view outside the blind, but the animal(s) cannot see anything within the interior of the blind, including movement by a person within the blind.

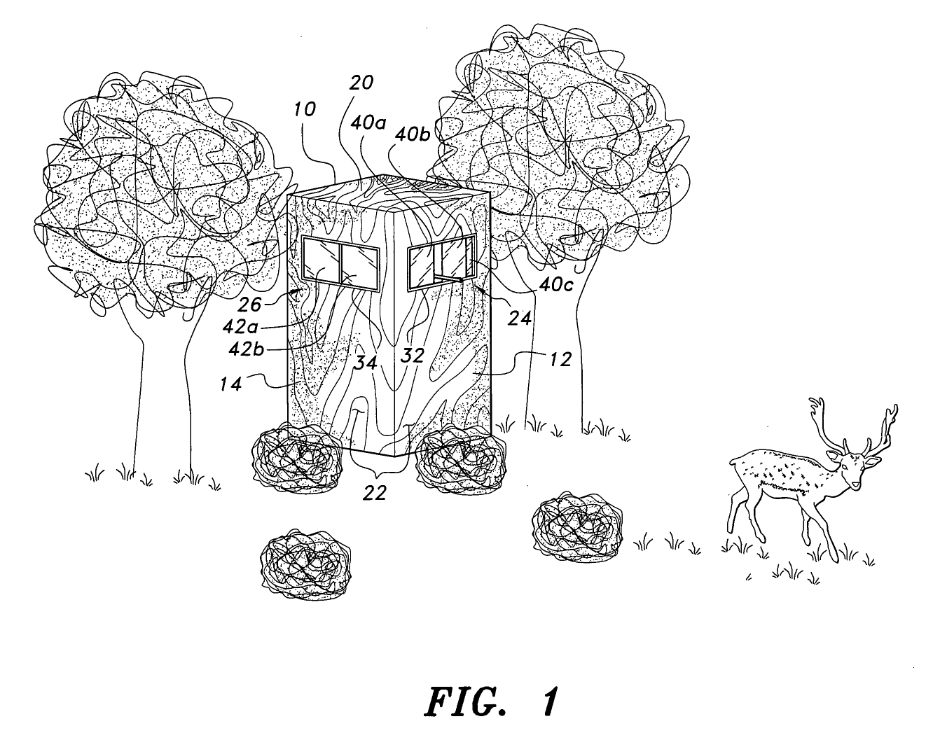

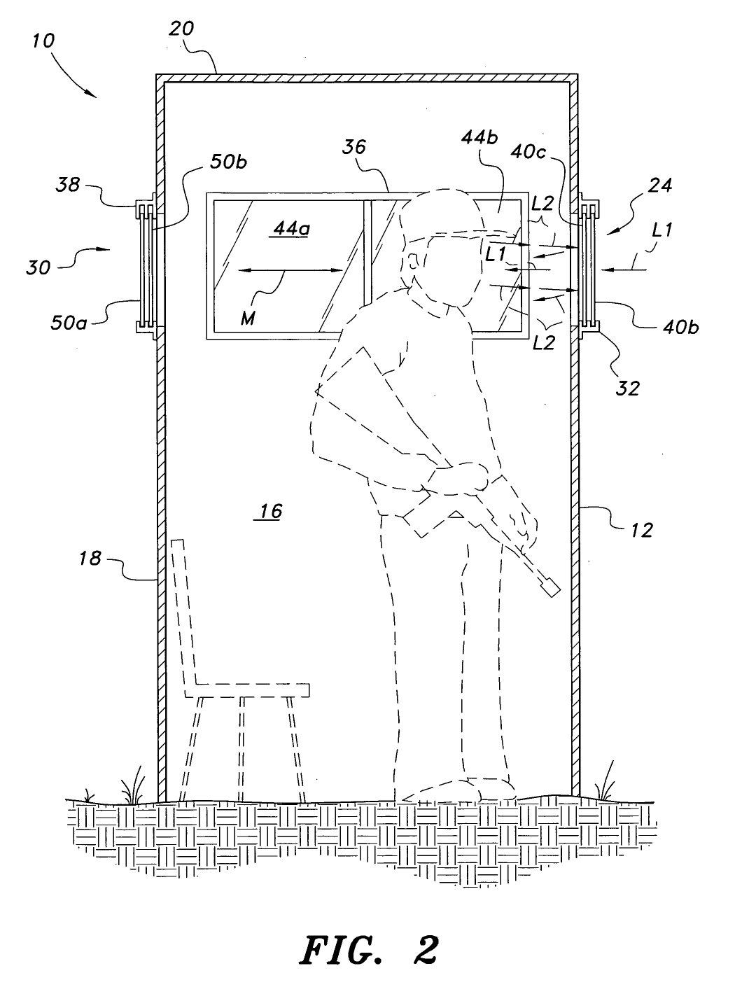

FIG. 1 is an environmental perspective view of a hunting (or photography, etc.) blind 10 having a series of one-way window panes installed therein. The blind 10 is preferably constructed from a number of standard four foot by eight foot rigid plywood sheets, or other suitable rigid sheet material. Using such sheet material the blind 10 has a square planform four feet on each side, with a front wall 12, mutually opposite first and second side walls 14 and 16, and a rear wall 18; the second side wall 16 and rear wall 18 are shown in FIG. 2. A door (not shown) may be cut in the rear wall 18 or other wall, as desired. A half length sheet forms the roof panel 20. Each of the walls 12 through 18 and roof 20 may be provided with a camouflage pattern 22 on their outer surfaces, if so desired. Other panel or sheet dimensions may be used alternatively as desired; the overall dimensions of the blind 10 are not critical to the present invention.

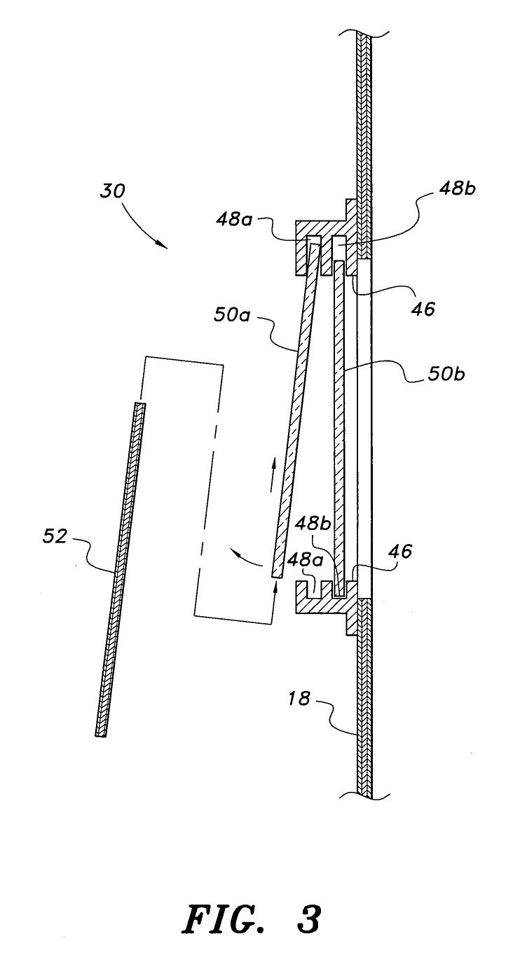

FIG. 2 provides a side elevation view in section through the blind 10, including a showing of a front window assembly 24, second side window assembly 28, and rear window assembly 30; the first side window assembly 26 is shown in FIG. 1. Each window assembly 24 through 30 has a frame, respectively 32 through 38. The frames are preferably formed of vinyl plastic to provide lower friction for the sliding window panes contained therein, but other materials may be used as desired. Each of the frames 32 through 38 includes at least two window tracks formed therein, as shown in the detailed elevation view in section of FIG. 3 with its rear window assembly 30 and frame 38 and discussed further below. It should be noted that while a rear window assembly 30 is illustrated in FIGS. 2 and 3, such a rear window assembly is not a requirement, but is shown to indicate that each of the walls 12 through 18 may be provided with such a window assembly if so desired. The function of the one way window panes is also indicated in FIG. 2, with light from the exterior passing freely through the panes, as indicated by the light transmission arrows L1. However, light reflected from objects within the blind is reflected by the coated surface of the one-way panes and does not leave the blind, as indicated by the reflected light arrows L2.

Each of the frames preferably includes at least two laterally sliding window panes therein, with each of the panes being formed to provide one way vision therethrough. In the example of FIG. 1, the front window assembly 24 includes three separate and independent panes therein, comprising a first outboard pane 40a, a central pane 40b, and a second outboard pane 40c opposite the first outboard pane. The two outboard panes 40a and 40c slide laterally within one of the tracks or channels of the frame 32, with the central pane 40b sliding within a separate track in the frame. In the example of FIG. 1, it will be noted that the central pane 40b has been slid laterally to one side, nearly covering the second outboard pane 40c, to allow a hunter within the blind 10 to extend his gun barrel through the resulting opening for a clear shot at the game outside the blind. Otherwise, the hunter may center the central pane 40b to provide an essentially continuous reflective surface across the three panes 40a, 40b, and 40c, to prevent wildlife from seeing into the interior of the blind.

The first side window assembly 26 of FIG. 1 and the second side window assembly shown in FIG. 2 each have only two panes installed therein, with the first side window assembly including first and second panes 42a and 42b and the second side window assembly having first and second panes 44a and 44b. It will be seen that either or both of these side window assemblies may include three panes if so desired, and/or the front window assembly 24 may have only two panes, if so desired. The specific number of panes and their fixed or sliding relationship to one another is not critical, so long as at least one of the panes in each of the window assemblies is laterally slidable to provide an opening from the interior of the blind to the exterior. FIG. 2 also shows the laterally sliding movement of the first pane 44a of the second side window assembly 28, indicated by the lateral movement arrow M in FIG. 2.

FIG. 3 provides a detailed elevation view in section of one of the window assemblies of the blind, e.g., the rear window assembly 30 shown generally in FIG. 2. The rear window assembly 30 includes a frame 38, similar to the window frames of the other window assemblies. The frame 30 has an interior periphery 46 with two window pane tracks 48a and 48b formed therein; these features, i.e., the interior periphery and its tracks, are common to each of the window assemblies of the blind 10. The window panes, e.g., first and second rear window panes 50a and 50b, slide laterally in the two tracks 48a and 48b.

It will be noted that the upper portions of the tracks or channels are somewhat deeper than the lower portions of the tracks or channels. These tracks or channels are preferably formed continuously about the inner periphery 46 of each frame, but the shallower lower portions allows the window panes, e.g., panes 50a and 50b, to be lifted upwardly into their upper channels and their lower edges to be withdrawn from the lower channels, as indicated in FIG. 3. This allows the panes to be removed from any or all of their respective frames, for storage and protection when the blind is not in use. This allows the hunter or user of the blind to protect the panes from continuous exposure to the elements, thus prolonging the life of any one way protective coating or the like used with the panes. Protective window pane replacement panels 52 formed of more economical material, e.g., plywood or a plasticized fiberboard (e.g., Masonite) may be installed in place of the panes, in the same manner used to remove and replace the panes. Again, the exemplary rear window frame assembly 30 shown in FIG. 3 has essentially the same configuration as the other window frame assemblies of the present blind, with all other assemblies providing for the removal and replacement of their panes and the removable installation of protective replacement panels in place of the panes.

In conclusion, the hunting (or photography, etc.) blind with its one-way windows provides the hunter or other person within the blind with relative comfort, as the blind may remain completely closed from the elements at all times the window panes are closed. Yet, the person within the blind can readily observe wildlife and game outside the blind, and remain completely concealed from that wildlife. The sliding panes allow the hunter to open one of the panes at the last minute for a shot at game, without revealing his or her presence until the last second. The easily removable and replaceable panes allow those panes to be removed from a blind that remains outdoors at all times, thus protecting the one way coating of the panes from damage due to sunlight and ultraviolet. Inexpensive protective panels may be installed in lieu of the panes, to prevent birds or other animals from nesting within the blind when not in use. Accordingly, the present blind will be greatly appreciated by hunters, photographers, and other observers of nature and wildlife.

It is to be understood that the present invention is not limited to the embodiments described above, but encompasses any and all embodiments within the scope of the following claims.

I claim:

1. A hunting blind with one-way windows for concealing a person therein, the hunting blind comprising:
a front wall, a first side wall, a second side wall opposite the first side wall, and a rear wall;
a window frame installed in the front wall, the window frame having an interior periphery;
a plurality of window pane tracks disposed within the interior periphery of the window frame; and
a plurality of one-way window panes disposed within the window pane tracks of the window frame, at least one of the window panes selectively sliding laterally within one of the window pane tracks so that the at least one window pane may be selectively opened and closed by the person within the hunting blind.

2. The hunting blind with one-way windows according to claim 1, wherein each of the one-way window panes is removably disposed within the window frame, the hunting blind further comprising a plurality of protective window pane replacement panels interchangeable with the one-way window panes.

3. The hunting blind with one-way windows according to claim 2, wherein each of the protective window pane replacement panels is formed of materials selected from the group consisting of plywood and plasticized fiberboard.

4. The hunting blind with one-way windows according to claim 1, wherein the window frame includes three one-way window panes slidably disposed therein.

5. The hunting blind with one-way windows according to claim 1, wherein the window frame includes two one-way window panes slidably disposed therein.

6. The hunting blind with one-way windows according to claim 1, further including a window frame disposed within at least the front wall, the first side wall, and the second side wall, each of the window frames having a plurality of one-way window panes disposed therein.

7. The hunting blind with one-way windows according to claim 1, wherein each of said walls is formed of plywood.

8. The hunting blind with one-way windows according to claim 1, wherein each of said walls has an exterior surface having a camouflage pattern disposed thereon.

9. A hunting blind with one-way windows for concealing a person therein, the hunting blind comprising:
a front wall, a first side wall, a second side wall opposite the first side wall, and a rear wall;
a window frame installed in the front wall, the window frame having an interior periphery;
a plurality of window pane tracks disposed within the interior periphery of the window frame;
a plurality of one-way window panes removably disposed within the window pane tracks; and
a plurality of protective window pane replacement panels interchangeable with the one-way window panes.

10. The hunting blind with one-way windows according to claim 9, wherein at least one of the window panes is selectively slidable laterally within one of the window pane tracks so that the at least one window pane may be selectively opened and closed by the person within the hunting blind.

11. The hunting blind with one-way windows according to claim 9, wherein each of the protective window pane replacement panels is formed of materials selected from the group consisting of plywood and plasticized fiberboard.

12. The hunting blind with one-way windows according to claim 9, wherein the window frame includes three one-way window panes slidably disposed therein.

13. The hunting blind with one-way windows according to claim 9, wherein the window frame includes two one-way window panes slidably disposed therein.

14. The hunting blind with one-way windows according to claim 9, further including a window frame disposed within at least the front wall, the first side wall, and the second side wall, each window frame having a plurality of one-way window panes disposed therein.

15. The hunting blind with one-way windows according to claim 9, wherein each said wall is formed of plywood.

16. The hunting blind with one-way windows according to claim 9, wherein each said wall has an exterior surface having a camouflage pattern disposed thereon.
